(19) United States
(12) Patent Application Publication
(10) Pub. No.: US 2021/0178414 A1
(43) Pub. Date: Jun. 17, 2021

(54) SPRAY PUMP

(71) Applicant: SAMHWAP&T CO., LTD, Uiwang-si, Gyeonggi-do (KR)

(72) Inventors: Kyungchang LEE, Uiwang-si, Gyeonggi-do (KR); Joonhong LEE, Siheung-si, Gyeonggi-do (KR)

(73) Assignee: SAMHWAP&T CO., LTD, Uiwang-si, Gyeonggi-do (KR)

(21) Appl. No.: 17/269,265

(22) PCT Filed: Oct. 24, 2018
(86) PCT No.: PCT/KR2018/012629

§ 371 Date: Feb. 18, 2021

(30) Foreign Application Priority Data
Sep. 20, 2018 (KR) 10-2018-0112624

(51) Int. Cl. B05B 11/00

(52) U.S. Cl. CPC B05B 11/3001; B05B 11/3074; B05B 11/3067; B05B 11/3052; B05B 11/3047

(57) ABSTRACT

A spray pump is disclosed. A spray pump according to one aspect of the present invention comprises: a housing having an inlet space and coupled to a container inlet; a housing cover coupled to an upper end of the housing; a disk for opening or closing the housing according to a pressure of the inlet space; a valve movably inserted inside the housing cover and having a valve head, a valve passage formed in the valve head, and a valve body; a guide having a portion inserted into the valve body and another portion located outside the valve body, and including a guide passage corresponding to a flow passage through which content is discharged; a pump spring for providing an elastic force for urging the valve upward; a piston movably inserted into an outer circumferential surface of the guide, and opening or closing the guide passage by means of an upward and downward movement of the valve; a nozzle having a coupling protrusion coupled to the valve head and in communication with the valve passage; a valve ball positioned inside the nozzle and capable of closing the upper end of the valve passage; and a pump spring for urging the valve ball downward.

### BACKGROUND

### Technical Field

The present invention relates to a spray pump capable of spraying a content evenly.

### Description of the Related Art

In a cosmetic container and the like, a spray pump may be coupled to the opening at the upper part of a container holding a liquid content such as a perfume, etc., to eject and spray the content to the exterior in designated amounts. When the user presses down on a nozzle corresponding to a button so as to spray the liquid content, the content that had entered the inside of the spray pump may be pressurized, move upward along the discharge passage, and be sprayed through the nozzle. When the pressure on the nozzle is released, the discharge passage may be mechanically closed by the rising of the nozzle, the pressure inside the pump may be lowered, and the content may be drawn in from the container to make up for the pressure loss.

A spray pump such as the above is being used not only for spraying perfumes and cosmetics but also a variety of other contents such as air fresheners, insecticides, etc. Due to the convenience of ejecting designated amounts of a content with a single pressing of the nozzle button, without having the content exposed to the exterior, use of the spray pump continues to grow.

A conventional spray pump may have the orifice, for spraying the content, formed with a very small diameter in order to spray the content in the form of fine particles. As a result, it may occur that the pumped liquid content is unable to easily pass through the orifice having a small diameter, and this in turn can result in an inability to eject a content in a uniform manner. Also, in the conventional spray pump, the length of the flow path exposed to outside air is long. This can incur problems of the content evaporating, spoiling, or being polluted by impurities.

### SUMMARY OF THE INVENTION

### Technical Problem

The present invention, which has been derived to resolve the problem above, aims to provide a spray pump that is capable of ejecting a content in a uniform manner.

Also, the present invention aims to provide a spray pump in which the length of the flow path exposed to outside air is minimized so as to prevent the content from being evaporated or contaminated.

Other objectives of the present invention will be more clearly appreciated from the embodiments set forth below.

### Technical Solution

A spray pump according to one aspect of the present invention may include: a housing that has an inflow space and is configured to be coupled to the opening of a container; a housing cover that is coupled to an upper end of the housing; a disk that is configured to open or close the housing according to the pressure of the inflow space; a valve that is movably inserted through the inside of the housing cover and includes a valve head, a valve passage formed in the valve head, and a valve body; a guide that has a portion inserted in the valve body and a remaining portion positioned outside the valve body and includes a guide passage corresponding to a flow path for discharging a content; a pump spring that is configured to provide an elastic force pressing the valve upward; a piston that is movably inserted onto the outer perimeter of the guide and is configured to open or close the guide passage by way of a vertical movement of the valve; a nozzle that includes a valve insertion protrusion, which may be coupled to the valve head, and connects with the valve passage; a valve ball that is positioned at the inside of the nozzle and is capable of closing an upper end of the valve passage; and a pump spring that is configured to press the valve ball downward.

A spray pump based on the present invention can include one or more of the following features. For example, an insert including an orifice can be inserted into the nozzle, and the upper end of the valve passage can be positioned lower than the orifice.

The pump spring can be inserted onto the periphery of the valve and can have one end supported by the housing cover.

The guide passage can include a first guide passage that is formed in the periphery of the guide and a second guide passage that connects with the first guide passage and is formed along the lengthwise direction of the guide to connect directly with the valve passage, while the piston can open or close the first guide passage.

A protrusion can be formed on the outer perimeter of the guide, and an indentation in which the protrusion may be inserted can be formed in the inner perimeter of the valve body.

A gap that allows an entry of air to the inside of the container can be formed at a coupling portion between the valve and the housing cover and at a coupling portion between the housing cover and the housing.

The nozzle can include a nozzle passage, through which a fluid discharged from the valve passage may move, and an insert protrusion, onto which an insert may be inserted, while the nozzle passage can be positioned below the insert protrusion.

The insert protrusion can extend downward from an upper surface of the nozzle and can extend horizontally.

### Advantageous Effects

The present invention can provide a spray pump that is capable of ejecting a content in a uniform manner.

Also, the present invention can provide a spray pump in which the length of the flow path exposed to outside air is minimized to prevent the content from being evaporated or contaminated.

### BRIEF DESCRIPTION OF THE DRAWINGS

FIG. 1 is a cross-sectional view illustrating a spray pump according to an embodiment of the present invention.

FIG. 2 is an exploded perspective view of the spray pump illustrated in FIG. 1.

FIG. 3 is a perspective view illustrating the disk in a spray pump according to an embodiment of the present invention.

FIG. 4 is a cross-sectional view illustrating the spray pump in FIG. 1 when the nozzle is moved downward.

FIG. 5 is a magnified view of part A in FIG. 4.

FIG. 6 is a cross-sectional view illustrating the entry of air in FIG. 4.

### DETAILED DESCRIPTION OF THE INVENTION

Below, a detailed description is provided of certain embodiments of the present invention, with reference to the appended drawings. In the descriptions referencing the appended drawings, the same reference numerals are assigned to the same or corresponding elements, regardless of the figure number, and redundant descriptions are omitted.

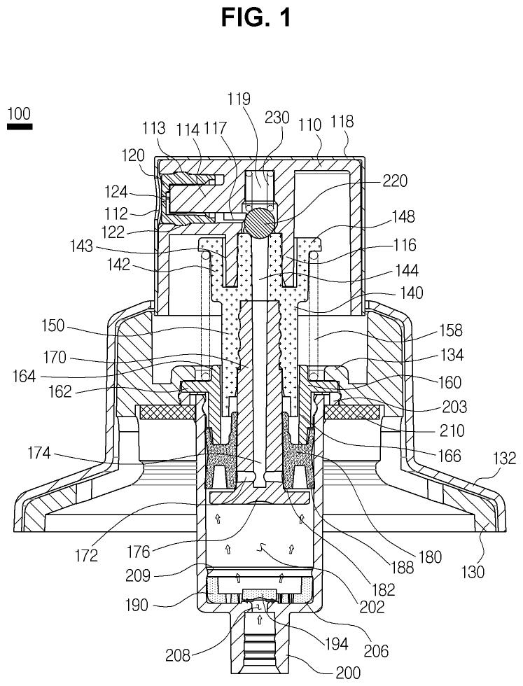

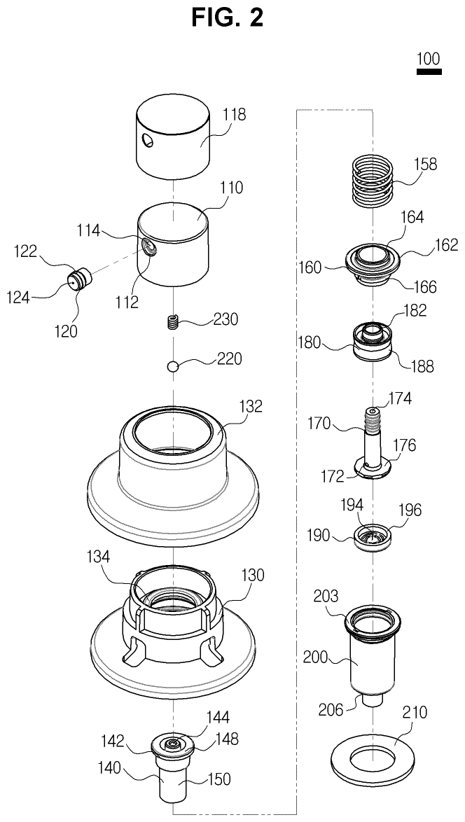

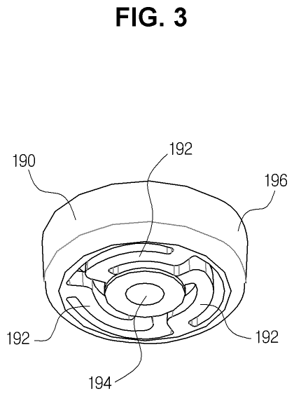

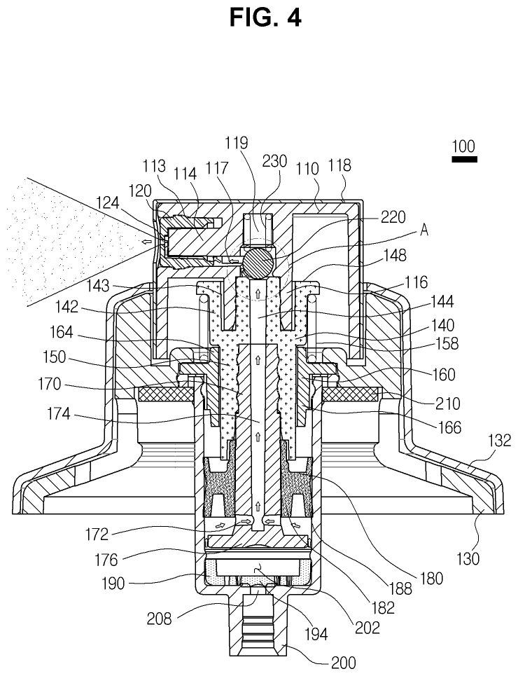

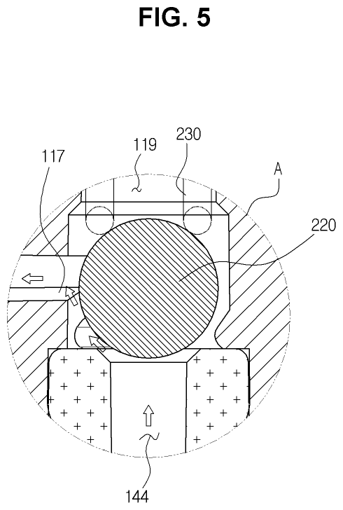

FIG. 1 is a cross-sectional view illustrating a spray pump 100 according to an embodiment of the present invention, and FIG. 2 is an exploded perspective view of the spray pump 100 illustrated in FIG. 1. FIG. 3 is a perspective view illustrating the disk 190 in a spray pump 100 according to an embodiment of the present invention. FIG. 4 is a cross-sectional view illustrating the spray pump in FIG. 1 when the nozzle 110 is moved downward, and FIG. 5 is a magnified view of part A in FIG. 4.

Incidentally, FIG. 1 illustrates the spray pump 100 when there is no external force applied, so that the nozzle 110 is raised as much as possible. Also, in FIG. 1, the arrows illustrate the flow of the content entering the inside of the housing 200.

Referring to FIGS. 1 to 5, a spray pump 100 according to this embodiment can be coupled to the upper end of a container (not shown) to spray a liquid content, which was injected into the container, in the form of fine particles, etc. The spray pump 100 according to this embodiment is not limited by the type or material of the coupled container or by the form, quality, and type of the sprayed content.

A cap 130 may be coupled to the opening of the container, and a cap cover 132 may be coupled to an upper portion of the cap 130. A packing 210 can be provided between the container and the cap 130 to prevent the content from leaking to the exterior. Also, a cover flange 162 of a housing cover 160 may be positioned between the packing 210 and an internal protrusion 134 of the cap 130. This may prevent the housing cover 160 from moving in position with respect to the cap 130.

The cap cover 132 may be coupled to an upper portion of the cap 130 to prevent the outer surface of the cap 130 from being exposed to the exterior. At the upper end of the cap cover 132, a through-hole (no number assigned) may be formed, through which a nozzle 110 and a nozzle cap 118 can be inserted in a manner that allows vertical movement. Between the nozzle cap 118 and the cap cover 132, a gap may be formed, through which air can enter into the inside of the housing 200 and the inside of the container.

The housing 200 may be positioned at the lowermost portion of the spray pump 100 and may provide an inflow space 202, which may be positioned within the container and into which the content can enter. The housing 200 may be structured such that the upper end and the lower end are both open and may have the inflow space 202 formed inside into which the content can enter. A housing cover 160 may be coupled to an upper portion of the housing 200.

The inflow space 202 of the housing 200 may correspond to a space that can receive an entry of the content through a disk 190. When the nozzle 110, piston 180, valve 140, and guide 170 are raised so that the pressure within the inflow space 202 is a vacuum or a near-vacuum, the content may be drawn into the inflow space 202, as the pressure in the container is higher than in the inflow space 202 (see the arrows of FIG. 1). Since the upper portion of the inflow space 202 is closed by the piston 180 and the guide 170, the content may not flow to the exterior and may remain only in the inflow space 202, when the nozzle 110 is not in a pressed state.

At the upper end of the housing 200, an outwardly protruding housing flange 203 may be formed. A lower surface of the housing flange 203 may contact the packing 210. Also, the cover flange 162 of the housing cover may be positioned at an upper portion of the housing flange 203. The cover flange 162 may be pressed downward by the internal protrusion 134 of the cap 130, and as a result, the housing 200 may also be coupled to be constricted in vertical movement with respect to the container.

The inner perimeter of the housing 200 can be formed straight, without any steps formed. The inner perimeter of the housing 200 may tightly contact the outer piston 188 of the piston 180. As a result, the content can be prevented from leaking, and the inside of the inflow space 202 can maintain a vacuum.

The housing cover 160 may be coupled to an upper portion of the housing 200 and may have a valve 140 penetrating therethrough. The housing cover 160 may include, with respect to the cover flange 162, a cover upper part 164 that protrudes upward and a cover lower part 166 that protrudes downward.

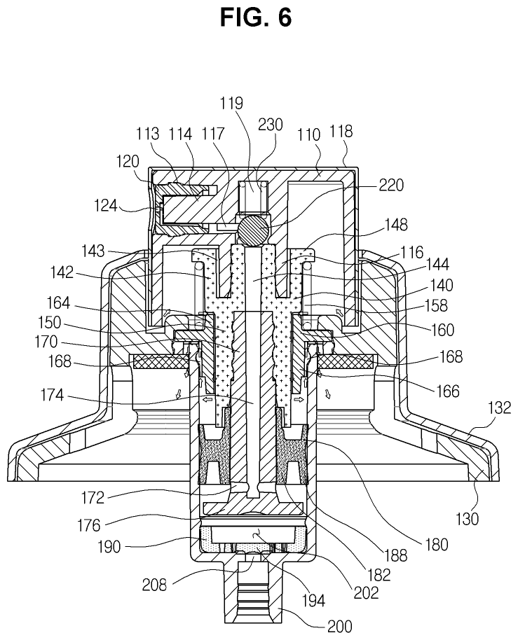

The cover lower part 166 may be inserted through an upper portion of the housing 200. The valve 140 may be inserted into the hollow cavity of the cover lower part 166. Referring to FIG. 6, a gap for forming an air passage 168 may be formed between the outer perimeter of the cover lower part 166 and the inner perimeter of the housing 200. A gap for forming an air passage may also be formed between the inner perimeter of the cover lower part 166 and the outer perimeter of the valve 140. Through such an air passage, air from the exterior may enter the housing 200 and subsequently enter the container.

The cover flange 162 may be a portion that protrudes outward in a certain length from the outer perimeter of the housing cover 160. The diameter of the cover flange 162 can be the same or almost the same as the diameter of the housing flange 203 of the housing 200. The cover flange 162 may be mounted on the upper portion of the housing flange 203. Also, the cover flange 162 may be pressed downward by the internal protrusion 134 of the cap 130. As a result, any vertical movement of the housing cover 160 may be prevented. The upper surface of the cover flange 162 may contact the lower end of a pump spring 158.

The cover upper part 164 may be a hollow tube that protrudes upward from the cover flange 162 and may have the valve 140 penetrating therethrough. A pump spring 158 may be positioned around the cover upper part 164. When the nozzle 110 is pressed downward, the end portion of the cover upper part 164 may contact the valve 140, preventing any further downward movement of the valve 140 (see FIG. 4).

The valve 140 may be inserted through the inside of the housing cover 160 and may move vertically with respect to the housing cover 160 so as to open or close the flow path through which the content may be discharged. The valve 140 may be structured as a hollow tube, with both the upper end and lower end open, and may include a valve head 142, a valve passage 144, and a valve body 150.

The valve head 142 may be formed with a diameter somewhat larger than that of the valve body 150 and may be positioned at the outside of the housing cover 160. The valve head 142 at its center may include a valve passage 144 that penetrates therethrough along its entire lengthwise direction. The valve passage 144 may be the part through which the content that has been transported through the guide 170 passes, and the content that passes through the valve passage 144 may be sprayed through the nozzle 110 and the insert 120 to the exterior.

The upper end of the valve passage 144 can be closed by a valve ball 220. When the nozzle 110 is pressed downward and the pressure of the inflow space 202 is increased, the valve ball 220 may be moved upward by the pressure increase to open the valve passage 144 (see FIG. 4 and FIG. 5). When there is no external pressure applied, the valve ball 220 may be pressed downward by a valve spring 230 to close the valve passage 144.

The upper end of the valve passage 144 can be formed lower than the orifice 124, which corresponds to the passage for spraying the fluid. This is to decrease the pressure loss of the content by shortening the path of movement of the fluid, i.e. the content. Due to the decreased pressure loss of the content, the content can be sprayed through the orifice 124 in a uniform manner.

Around the periphery of the valve passage 144, there may be formed a valve cavity 143. The valve cavity 143 may have an open top and may have a certain depth. A valve insertion protrusion 116 of the nozzle 110 may be inserted into the valve cavity 143. As a result, the valve 140 and the nozzle 110 may move together as an integrated body.

A valve flange 148 may protrude outward at the upper end of the valve head 142. A lower surface of the valve flange 148 may contact the pump spring 158. Thus, the valve 140 may receive an upwardly pressing elastic force applied by the pump spring 158.

The valve body 150 may be divided from the valve head 142 by a step (no number assigned). The valve body 150 may be movably inserted at the center of the housing cover 160. Also, the valve body 150 may have a guide 170 inserted and screw-joined therein over the entire lengthwise direction. The guide 170 may not move vertically with respect to the valve body 150. As a result, the valve 140 and the guide 170 may move vertically as an integrated body. Also, a gap for forming an air passage may be formed between the outer perimeter of the valve body 150 and the inner perimeter of the housing cover 160.

The pump spring 158 may be positioned between the housing cover 160 and the valve 140 to provide an elastic force that moves the valve 140 upward. Since the housing cover 160 and the housing 200 do not move vertically with respect to the container, only the valve 140 and the guide 170 may move vertically. That is, when an external force is applied, the valve 140 and the guide 170 may be moved downward (see FIG. 4), and when the external force is removed, the valve 140 and the guide 170 may be moved upward by the elastic restoring force of the pump spring 158 and returned to their original positions (see FIG. 1).

The pump spring 158 may not contact the content while positioned around the valve 140 and housing cover 160. Thus, any contamination of the content by the metallic material of the pump spring 158 can be prevented, and the problem of the durability of the pump spring 158 being lowered by the content can be avoided.

The guide 170 may move vertically as an integrated body with the valve 140 and may provide guide passages 172, 174 through which the content can move. The guide 170 may be shaped as a hollow cylinder and may have a guide head 176 formed at its lower end, where the guide head 176 may have a larger diameter. Also, a portion of the guide 170 may be inserted in the valve 140, while a remaining portion may be exposed outside the valve 140. The piston 180 may be positioned around the portion of the guide 170 that is exposed outside the valve 140.

The guide passage may include a first guide passage 172 and a second guide passage 174.

The first guide passage 172 may be formed perpendicularly to the lengthwise direction of the guide 170, and its opening may be formed in the outer perimeter of the guide 170. It is possible to have two or more first guide passages 172, of which the other ends may all connect with the second guide passage 174. The first guide passage 172 can be formed adjacent to the guide head 176 formed at the lower end of the guide 170.

The first guide passage 172 can be opened or closed by the piston 180. That is, when the nozzle 110 is raised, the first guide passage 172 may be closed by the piston 180 (see FIG. 1), with the result that the content within the inflow space 202 may not be sprayed. When the nozzle 110 is lowered, the first guide passage 172 may move beyond the piston 180 and be opened (see FIG. 4), with the result that the content can move through the first guide passage 172.

The second guide passage 174 may be formed in a direction perpendicular to that of the first guide passage 172, in the lengthwise direction of the guide 170. The upper end of the second guide passage 174 may connect directly with the valve passage 144.

The guide head 176 may be formed at the lower end of the guide 170 with a diameter somewhat larger than the diameter of the guide 170. The guide head 176 may have an outer diameter that is larger than the inner diameter of the inner piston 182. Thus, when the nozzle 110 is raised, the guide head 176 may be caught on the inner piston 182, which may limit the rising of the guide 170. Also, when the movement of the guide 170 is stopped, the movement of the valve 140, nozzle 110, and nozzle cap 118, which move together as an integrated body, may be stopped as well.

The diameter of the guide head 176 can be formed somewhat smaller than the inner diameter of the inflow space 202 of the housing 200. Referring to FIG. 4, the content that had entered the inflow space 202 may enter the first guide passages 172 through the gap formed between the guide head 176 and the inner perimeter of the housing 200.

The piston 180 may be inserted onto the periphery of the guide 170 and may move vertically along the lengthwise direction of the guide 170 to open or close the first guide passage 172. The piston 180 may include an inner piston 182 and an outer piston 188 formed as an integrated body.

The inner piston 182 may have the shape of a hollow tube, and at the inside of the inner piston 182, the guide 170 may be inserted in a movable manner. The inner perimeter of the inner piston 182 may tightly contact the outer perimeter of the guide 170 such that the content does not leak out. For implementing such a sealing function, the piston 180 can be formed from a flexible material such as rubber, etc.

The lower portion of the inner piston 182 can open or close the first guide passage 172. That is, depending on the relative positions of the guide 170 and the piston 180, the first guide passage 172 can be opened or closed by the inner piston 182. The outer piston 188 may be formed around the periphery of the inner piston 182.

The upper end of the inner piston 182 can be caught on a step (no number assigned) formed on the inside of the valve 140. That is, referring to FIG. 4, when the nozzle 110 is moved down, the upper end of the inner piston 182 may be caught on the step formed on the inside of the valve 140, so that the valve 140 may be moved down together. Also, referring to FIG. 1, when the nozzle 110 is moved up, the outer piston 188 may be caught on the housing cover 160 to be stopped in moving further upward, and the inner piston 182 may be positioned outside the valve 140 without being inserted therein.

The outer perimeter of the outer piston 188 may tightly contact the inner perimeter of the housing 200. As a result, the content that had entered the inside of the housing 200 can be prevented from leaking out, and the downward movement of the piston 180 may be limited. However, the guide 170 that is movably inserted through the inside of the piston 180 can undergo a further downward movement, with the result that the first guide passage 172 may move beyond the inner piston 182 and be exposed outside (see FIG. 4).

The disk 190 may, while positioned on the mount step 206 within the housing 200, open or close the inflow hole 208 according to the pressure inside the inflow space 202. The disk 190 can be formed from a material having an elastic quality such as rubber, flexible plastic, etc. The disk 190 may include a connection member 192, an operating plate 194, and a disk body 196.

The disk body 196 may be the portion that is placed on the mount step 206 and may form the outer body of the disk 190. An upper end of the disk body 196 may be caught on the curb step 205, whereby the disk 190 may be prevented from becoming detached from the mount step 206.

The connection member 192 may correspond to a portion that connects the disk body 196 with the operating plate 194. The connection member 192 can be formed from a material having an elastic quality to be capable of changing length. This allows the operating plate 194 to move upward (see FIG. 1) from its original position (see FIG. 4).

The operating plate 194 may be connected to the connection member 192 and may open or close the inflow hole 208. The diameter of the operating plate 194 can be formed somewhat larger than the diameter of the inflow hole 208.

As illustrated in FIG. 1, when the pressure inside the inflow space 202 is lower compared to the inside of the container, the operating plate 194 may be raised due to the pressure difference, and the inflow hole 208 may be opened. As a result, the content within the container may be moved to the inflow space 202. Also, as illustrated in FIG. 4, when the pressure inside the inflow space 202 is higher compared to the inside of the container, the operating plate 194 may remain at its original position to close the inflow hole 208. As a result, the content in the container cannot move to the inflow space 202, and the content that had already entered the inflow space 202 may be sprayed through the nozzle 110 to the exterior.

The nozzle 110 may be coupled to the upper end of the valve 140 and may continue from the valve 140 to provide a passage through which the content may be discharged. Also, the nozzle 110 may protrude to the outside of the cap 130 to be positioned for pressing by the user. At an upper portion of the cap 130, a space may be formed in which the nozzle 110 can move vertically.

In the center on the inside of the nozzle 110, a valve insertion protrusion 116 may be formed which can be inserted into the valve cavity 143. The valve insertion protrusion 116 may be inserted into the valve cavity 143 by way of a screw joint or a press fit. Thus, the nozzle 110 may not rotate with respect to the valve 140 but rather may move as an integrated body.

A nozzle passage 117 may be included within the nozzle 110. The nozzle passage 117 may be positioned below the insert protrusion 114. Also, referring to FIG. 5, the nozzle passage 117 may be positioned adjacent to the valve passage 144. That is, the upper end of the valve passage 144 may be positioned below the insert protrusion 114 and may be formed slightly below the upper end of the nozzle passage 117. As a result, the path from the upper end, i.e. the distal end, of the valve passage 144 to the orifice 124 can be minimized.

By forming the path of movement of the content with a short distance, pressure losses caused by friction during the movement can be minimized, and as a result, the content can be sprayed in a uniform manner.

The nozzle 110 can have a cylindrical shape of which only the lower side is open. Also, on the outer perimeter of the nozzle 110, an insert holder part 112 can be formed. An insert 120 may be inserted in the insert holder part 112. In the inner perimeter of the insert holder part 112, an insert groove 113 may be formed. A detent protrusion 122 formed on the outer perimeter of the insert 120 may be inserted in the insert groove 113. As a result, even as the content is sprayed, the insert 120 may not become detached from the insert holder part 112.

On the inside of the insert holder part 112, an insert protrusion 114 may be formed. The insert protrusion 114 can be a protrusion that protrudes downward from the upper surface of the nozzle 110 and then extends in a horizontal direction in a cylindrical shape. The insert 120 may be inserted onto the periphery of the insert protrusion 114. A gap may be present between the outer perimeter of the insert protrusion 114 and the inner perimeter of the insert 120, and the content may be sprayed through this gap to the exterior of the nozzle 110.

A nozzle cap 118 can be coupled to the exterior of the nozzle 110.

The insert 120 may be shaped as a hollow cylinder having only one end open and may be inserted onto the insert holder part 112. In the surface of the other end of the insert 120, an orifice 124 may be formed. The content may be sprayed through the orifice 124 in the form of fine particles. Between the closed other end of the insert in which the orifice 124 is formed and the end of the insert protrusion 114, a certain gap may be formed through which the content can move.

On the outer perimeter of the insert 120, a detent protrusion 122 may be formed. The detent protrusion 122 may be inserted in the insert groove 113 to prevent the insert 120 from becoming detached.

In the center at the inside of the nozzle 110, a center cavity 119 may be formed. The center cavity 119 may be formed with a certain depth and may be configured to receive a valve spring 230 inserted therein.

In the space formed below the center cavity 119, the valve ball 220 may be inserted. The valve ball 220 may be pressed downward by the valve spring 230 to close the valve passage 144. As a result, the content may not be discharged through the valve passage 144 to the exterior. Also, since the upper end of the valve passage 144 may be closed by the valve ball 220, the parts of the movement path of the content that come into contact with outside air (i.e. from the orifice 124 to the upper end of the valve passage 144) can be formed in a minimum distance.

The valve ball 220 can have a spherical shape and can be formed from a material such as metal, plastic resin, etc.

When the nozzle 110 is raised as in FIG. 1, the valve ball 220 may be pressed downward by the elastic force of the valve spring 230 to close the valve passage 144. Also, when the nozzle 110 is lowered as in FIG. 4 and FIG. 5, the valve ball 220 may be raised by the pressure increase of the content to open the valve passage 144. When a certain amount of the content is discharged through the valve passage 144 so that the pressure of the content is decreased, the valve ball 220 may be pressed downward by the elastic force of the valve spring 230 and may again close the valve passage 144.

Although a valve ball 220 according to this embodiment is illustrated as having a spherical shape, the present invention is not limited by the shape of the valve ball 220. Therefore, a valve ball according to another embodiment of the present invention can have any of a variety of shapes, such as for example a valve ball of which one portion has a spherical shape and a remaining portion has a cylindrical shape. Also, a valve ball 220 according to another embodiment of the present invention can have any of a variety of shapes other than a sphere, such as for example a conical shape, a frustoconical shape, etc.

The following describes the operation of a spray pump 100 according to this embodiment, with reference to FIG. 1, FIG. 4, and FIG. 5.

FIG. 4 is a cross-sectional view illustrating the spray pump in FIG. 1 when the nozzle 110 is moved downward. The arrows in FIG. 4 illustrate the discharge path of the content. FIG. 5 is a magnified view of part A in FIG. 4.

As illustrated in FIG. 1, when there is no external force applied on the nozzle 110, the positions of the nozzle 110, valve 140, and guide 170 may be raised as much as possible by the pump spring 158. Also, the rising of the guide 170 may cause the piston 180 to be raised as well, to be raised as much as possible and caught on the lower end of the housing cover 160. Here, the piston 180 may close the first guide passage 172 of the guide 170.

The rising of the valve 140 and guide 170 may cause the inflow space 202 inside the housing 200 to expand while in a sealed state, lowering the pressure and forming a vacuum or a near-vacuum. The inside of the container may maintain atmospheric pressure due to the inflow of outside air described later on. Therefore, as the pressure inside the container is higher than the pressure inside the inflow space 202, the disk body 196 may be raised by the pressure difference, and the inflow hole 208 may be opened. As the inflow hole 208 is opened, the content held in the container may be suctioned into the inflow space 202 (see arrows of FIG. 1). Here, the inner piston 182 may tightly contact the outer perimeter of the guide 170 to prevent any leaking of the content and to maintain the vacuum state of the inflow space 202. Also, the outer piston 188 may tightly contact the inner perimeter of the housing 200 to prevent any leaking of the content and to maintain the vacuum state of the inflow space 202.

From the state illustrated in FIG. 1, when the nozzle 110 is pressed downward in order to spray the content, the valve 140 and the guide 170 may move downward together with the nozzle 110. As the valve 140 moves a certain distance, the valve 140 may be caught on the piston 180, whereby the valve 140 and the piston 180 may move downward together. Also, since the outer perimeter of the piston 180 may be in tight contact with the inner perimeter of the housing 200, the guide 170 may move faster than the piston 180, and as a result, the guide head 176 may pass through the inside of the piston 180, increasing the gap between the two and opening the first guide passage 172.

As the piston 180 and guide 170 are lowered, the volume inside the inflow space 202 may be decreased, causing an increase in pressure. In particular, the pressure inside the inflow space 202 can be increased to or beyond a certain value, since the upper end of the valve passage 144 is closed by the valve ball 220. When the pressure inside the inflow space 202 is increased to or beyond a certain value, the valve ball 220 may be raised, while deforming the valve spring 230, to open the valve passage 144 (see FIG. 5). As a result, the content that had entered the inflow space 202 may sequentially pass through the first guide passage 172, the second guide passage 174, the valve passage 144, and the nozzle passage 117, to be sprayed through the orifice 124 to the exterior.

As the distance from the valve passage 144 to the orifice 124 is short, the loss of pressure of the content during movement can be reduced, whereby the content can be sprayed uniformly. Also, the short distance from the orifice 124 to the valve ball 220, corresponding to the part where there is contact with outside air, can resolve such problems as the content being evaporated, spoiled, contaminated by impurities, etc. When the pressure inside the inflow space 202 is increased, the operating plate 194 of the disk 190 may be moved down by the pressure to close the inflow hole 208.

From the state illustrated in FIG. 4, when the external pressure is removed, the nozzle 110, valve 140, guide 170, and piston 180 may be generally raised by the elastic restoring force of the pump spring 158. Here, the rising of the piston 180 and the guide 170 may cause a decrease in pressure inside the inflow space 202, with the result that the valve ball 220 may be pressed downward by the valve spring 230 to close the valve passage 144.

The following describes the inflow of outside air into a spray pump 100 according to this embodiment, with reference to FIG. 6.

FIG. 6 is a cross-sectional view illustrating the flow of outside air to the inside of the pump 100 and the container for a spray pump 100 according to an embodiment of the present invention. Incidentally, the arrows in FIG. 6 illustrate the flow of air.

Referring to FIG. 6, outside air may be drawn to the inside of the container. That is, air that enters through the gap formed between the nozzle cap 118 and the cap 130 may enter the inside of the nozzle 110 and then flow through the gap between the valve 140 and the housing cover 160, the gap between the housing cover 160 and the housing 200, and the gap between the housing 200 and the opening of the container, to enter the inside of the container. If the outside air does not enter the inside of the container, a vacuum would form inside the container, and it would not be possible to suction the content to the inside of the housing 200 with the weak vacuum generated in the inflow space 202. Thus, the passage for air movement may be formed to prevent the forming of a vacuum inside the container.

The inflow of outside air to the inside of the container and the spraying of the content that had entered the inside of the inflow space 202 can occur simultaneously.

While the foregoing provides a description with reference to an embodiment of the present invention, the person having ordinary skill in the relevant field of art would understand that various modifications and alterations can be made to the present invention without departing from the spirit and scope of the present invention set forth in the scope of claims below.

What is claimed is:

1. A spray pump comprising:
a housing having an inflow space and configured to be coupled to an opening of a container;
a housing cover coupled to an upper end of the housing;
a disk configured to open or close the housing according to a pressure of the inflow space;
a valve movably inserted through an inside of the housing cover, the valve comprising a valve head, a valve passage, and a valve body, the valve passage formed in the valve head;
a guide having a portion thereof inserted in the valve body and a remaining portion thereof positioned outside the valve body, the guide comprising a guide passage corresponding to a flow path for discharging a content;
a pump spring configured to provide an elastic force pressing the valve upward;
a piston movably inserted onto an outer perimeter of the guide and configured to open or close the guide passage by way of a vertical movement of the valve;
a nozzle comprising a valve insertion protrusion and connecting with the valve passage, the valve insertion protrusion coupled to the valve head;
a valve ball positioned at an inside of the nozzle and capable of closing an upper end of the valve passage; and
a pump spring configured to press the valve ball downward.

2. The spray pump of claim 1, wherein an insert comprising an orifice is inserted into the nozzle, and
the upper end of the valve passage is positioned lower than the orifice.

3. The spray pump of claim 1, wherein the pump spring is inserted onto a periphery of the valve and has one end thereof supported by the housing cover.

4. The spray pump of claim 1, wherein the guide passage comprises a first guide passage and a second guide passage, the first guide passage formed in a periphery of the guide, the second guide passage connecting with the first guide passage and formed along a lengthwise direction of the guide to connect directly with the valve passage, and wherein the piston is capable of opening or closing the first guide passage.

5. The spray pump of claim 1, wherein a protrusion is formed on an outer perimeter of the guide, and an indentation configured to receive the protrusion inserted therein is formed in an inner perimeter of the valve body.

6. The spray pump of claim 1, wherein a gap allowing an entry of air to an inside of the container is formed at a coupling portion between the valve and the housing cover and at a coupling portion between the housing cover and the housing.

7. The spray pump of claim 1, wherein the nozzle comprises a nozzle passage and an insert protrusion, the nozzle passage allowing a movement of a fluid discharged from the valve passage, the insert protrusion configured to receive an insert inserted thereon, and
the nozzle passage is positioned below the insert protrusion.

8. The spray pump of claim 7, wherein the insert protrusion extends downward from an upper surface of the nozzle and extends horizontally.
